(19) United States
(12) Patent Application Publication
(10) Pub. No.: US 2016/0274884 A1
(43) Pub. Date: Sep. 22, 2016

(54) Method and System of Updating Digital Video Recorders

(71) Applicant: HANGZHOU HIKVISION DIGITAL TECHNOLOGY CO., LTD., Hangzhou (CN)

(72) Inventors: Chong Sun, Hangzhou (CN); Mingcheng Lv, Hangzhou (CN); Chenghua Sun, Hangzhou (CN)

(21) Appl. No.: 14/442,124

(22) PCT Filed: Nov. 11, 2013
(86) PCT No.: PCT/CN2013/086831

§ 371 Date: May 12, 2015

(30) Foreign Application Priority Data
Nov. 16, 2012 (CN) 201210466148.5

(51) Int. Cl. G06F 9/445; H04N 5/77

(52) U.S. Cl. CPC G06F 8/65; H04N 5/77

(57) ABSTRACT

A first digital video recorder (DVR) obtains a firmware version identity of at least one second DVR within a local area network (LAN) where the first DVR belongs, compares the obtained firmware version identity with a firmware version identity of the first DVR, determines a firmware version identity of the latest firmware version, obtains files of the latest firmware version from a third DVR that provides the firmware version identity of the latest firmware version, and performs version update using the files obtained.

### RELATED DOCUMENTS

The present disclosure claims priority of Chinese patent application No. 201210466148.5 titled “method and apparatus of mass updating digital video recorders” and filed on Nov. 16, 2012 with the Patent Office of the People's Republic of China, the disclosure of which is incorporated by reference in its entirety.

### TECHNICAL FIELD

The present disclosure relates to system update techniques, and particularly, to a method and a system of updating digital video recorders (DVR).

### BACKGROUND

Updating all of hard disc video recorders (i.e., digital video recorders, DVR) within a local area network (LAN) usually requires cooperation of a management server and a firmware server.

The management server sends configuration parameters of the firmware server to the DVRs which obtain files of a version from the firmware server by using the configuration parameters to perform the update.

### SUMMARY

Various examples of the present disclosure provide a method of updating DVRs to realize automatic update of DVRs and improve the efficiency of the update process.

Various examples of the present disclosure provide a system of updating DVRs to realize automatic update of DVRs and improve the efficiency of the update process.

A method of updating DVRs according to examples of the present disclosure may include:

obtaining, by a first DVR, a firmware version identity at least one second DVR within a LAN where the first DVR belongs;

comparing the obtained firmware version identity with a firmware version identity of the first DVR, determining a firmware version identity of the latest firmware version;

obtaining files of the latest firmware version from a third DVR that provided the firmware version identity of the latest firmware version; and

performing version update using the files obtained.

A system of updating DVRs according to examples of the present disclosure may include at least two DVRs,

a first DVR is configured to obtain a firmware version identity of at least one second DVR within a LAN where the first DVR belongs, compare the obtained firmware version identity with a firmware version identity of the first DVR, determine a firmware version identity of the latest firmware version, obtain files of the latest firmware version from a third DVR that provided the firmware version identity of the latest firmware version, and perform version update using the files obtained.

A DVR according to examples of the present disclosure may include:

a first request unit, configured to obtain a firmware version identity of at least one second DVR; and

a second request unit, configured to compare the obtained firmware version identity with a firmware version identity of the DVR, determine a firmware version identity of the latest firmware version, obtain files from a third DVR that provided the version identity of the latest firmware version, and perform version update using the files obtained.

According to the examples, a first DVR requests firmware version identities and IP addresses of other DVRs in the LAN where it belongs, determines a firmware version identity of the latest firmware version, requests files of the latest firmware version from a third DVR of the latest firmware version using the IP address corresponding to the firmware version identity of the latest firmware version, and updates the firmware version of the first DVR using the obtained files of the latest firmware version. As such, DVRs within a LAN can perform automatic update after one or multiple of the DVRs are updated, and no management server or firmware server is required in the network. Further, the update procedures which were implemented in a management server and a firmware server are now distributed to multiple DVRs in the LAN, which improves the efficiency of the update process, especially when there are a large number of DVRs to be updated.

### BRIEF DESCRIPTION OF THE DRAWINGS

Features of the present disclosure are illustrated by way of example and not limited in the following figures, in which like numerals indicate like elements, in which:

FIG. 1 is a schematic diagram illustrating a communication system;

FIG. 2 is a flowchart illustrating a method of updating DVRs in accordance with examples of the present disclosure;

FIG. 3 is a flowchart illustrating a method of updating DVRs in accordance with examples of the present disclosure;

FIG. 4 is a flowchart illustrating a method of updating DVRs in accordance with examples of the present disclosure;

FIG. 5 is a flowchart illustrating a method of updating DVRs in accordance with examples of the present disclosure;

FIG. 6 is a flowchart illustrating a method of updating DVRs in accordance with examples of the present disclosure;

FIG. 7 is a schematic diagram illustrating a system of updating DVRs in accordance with examples of the present disclosure;

FIG. 8 is a schematic diagram illustrating an example of a DVR in accordance with examples of the present disclosure.

### DETAILED DESCRIPTIONS

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. Quantities of an element, unless specifically mentioned, may be one or a plurality of, or at least one.

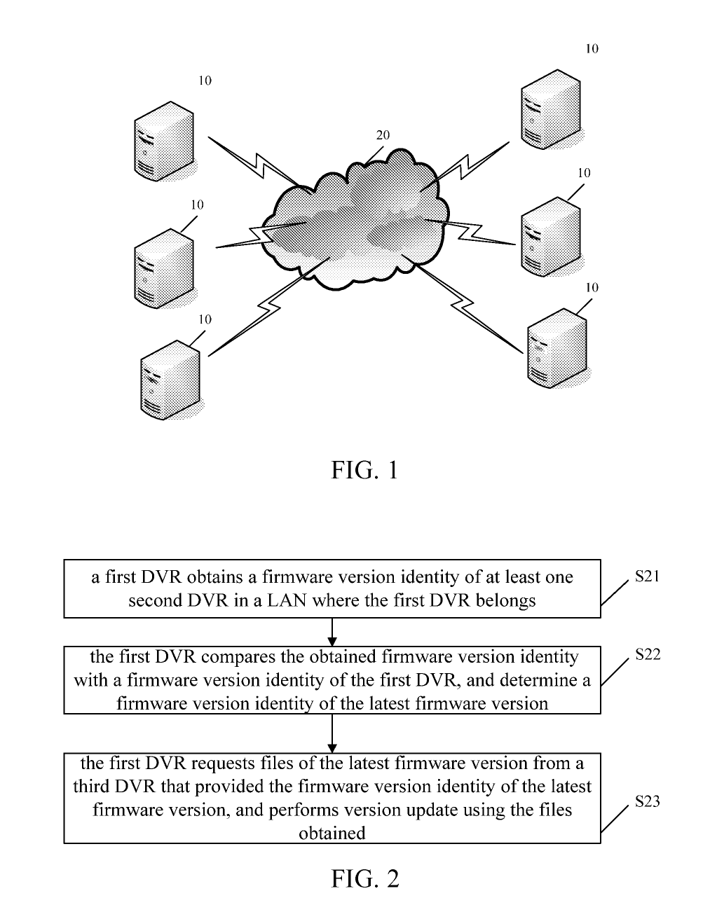

FIG. 1 is a schematic diagram illustrating a communication system in accordance with an example of the present disclosure. As shown in FIG. 1, the communication system may include plural DVRs 10 and a communication network 20. The communication network 20 may be a local area network (LAN) established using any LAN protocols. The plural DVRs 10 may communicate with each other via the communication network 20.

The following takes a process of updating a DVR in a LAN as an example to illustrate the technical mechanism of various examples. Other DVRs can initiate an update process in a similar manner provided by various examples of the present disclosure. The DVR that initiates the update process is also referred to as a to-be-updated DVR, i.e., a DVR that is to be updated.

FIG. 2 is a flowchart illustrating a method of updating DVRs in accordance with examples of the present disclosure. The method may include the following procedures.

At block S21, a first DVR obtains a firmware version identity of at least one second DVR within a LAN where the first DVR belongs.

At block S22, the first DVR compares the obtained firmware version identity with a firmware version identity of the first DVR, determines a firmware version identity of the latest firmware version.

At block S23, the first DVR obtains files of the latest firmware version from a third DVR that provides the firmware version identity of the latest firmware version, and performs version update using the files obtained.

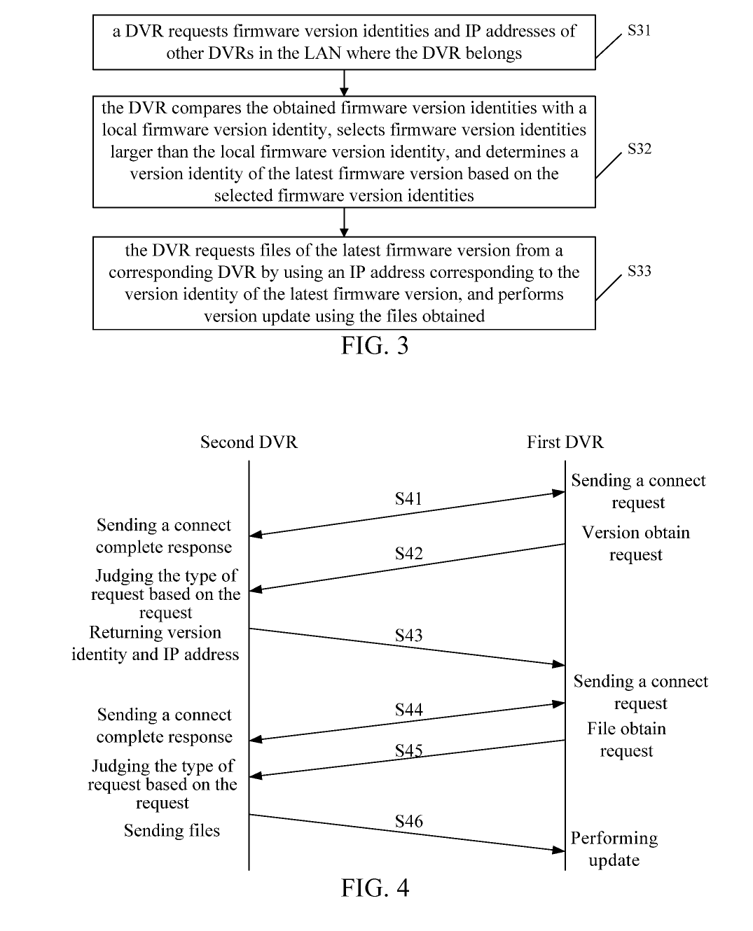

FIG. 3 is a flowchart illustrating a method of updating DVRs in accordance with examples of the present disclosure. The method may include the following procedures.

At block S31, a first DVR requests firmware version identities and IP addresses of other DVRs in the LAN where the first DVR belongs.

DVRs in the LAN may communicate with each other. In an example, the first DVR may obtain firmware version identities of other DVRs in the LAN by: sending a connect request to the other DVRs in the LAN, receiving a connect complete response from a second DVR, sending a version request (also referred to as first request) to the second DVR, and receiving a firmware version identity returned by the second DVR. Various examples may adopt conventional communication mechanisms, or a custom designed communication mechanism. For example, the connection request may be a Socket connect request, or the like.

In order to communicate with each other, the DVRs need to have communication addresses of other DVRs, e.g., IP addresses, MAC addresses or the like. In an example, the first DVR may search for other active DVRs in the LAN by using a search active device protocol (SADP) before sending the connect request to another DVR in the LAN. By using the SADP, the first DVR may obtain IP addresses of other active DVRs in the LAN so as to send the connect request to the DVRs found. DVRs in other examples may adopt other automatic discovery schemes to obtain communication addresses of other DVRs. In an example, the first DVR may obtain a communication address and an identity of another DVR through the above search process, record a relation which associates the communication address with the identity. In another example, the first DVR may number the other DVRs, and store a relation which associates the obtained communication address of a DVR with the number allocated to the DVR. Other examples may adopt other scheme to record the communication addresses of the DVRs. There are numerous other schemes which are thus not enumerated herein.

According to some examples, the first DVR may store communication addresses of other DVRs, e.g., in a list, for future use after discovering other active DVRs. In other examples, the first DVR may perform the above search process each time the update process is performed.

Update procedures may be performed when the DVR starts up by default, or may be performed when there is the need, or may be performed at pre-defined times. For example, a DVR may receive a startup command to start an update process, and execute the SADP procedures to discover other active DVRs in the LAN. The startup command may be a command received from an external device, or may be a command triggered by a timer in the DVR. In an example, the updating procedures may be a task configured in the DVR for system update.

At block S32, the first DVR compares the obtained firmware version identities with a local firmware version identity of the first DVR, and selects a firmware version identity larger than the local firmware version identity, thus the firmware version identity of the latest (or newest) firmware version is determined.

In an example, the procedure of selecting a firmware version identity of a firmware version newer than the local firmware version may include selecting a firmware version identity larger than the local firmware version identity. The procedure of determining the firmware version identity of the latest firmware version from the selected firmware version identities may include determining the largest firmware version identity. The manner of implementing this procedure is decided by the numbering scheme of the firmware version identities. The above merely takes a situation where a newer version has a larger value of the firmware version identity as an example, and other examples may adopt other manners to determine the latest firmware version.

At block S33, the first DVR sends a file request (referred to as second request) to a third DVR that provides the firmware version identity of the latest firmware version by using the IP address which is associated with the firmware version identity, and performs version update using files obtained.

In an example, the first DVR may obtain the files from the third DVR by: sending a connect request to the third DVR using the communication address (e.g., an IP address, a MAC address or the like) associated with the firmware version identity of the latest firmware version, receiving a connect complete response, sending the second request to the third DVR, and receiving files sent by the third DVR.

In an example, the first DVR may obtain the communication address of a second DVR when receiving the firmware version identity returned by the second DVR, and record a relation which associates the firmware version identity provided by the second DVR with the communication address of the second DVR. In another example, the first DVR may record the communication address of a second DVR when the first DVR discovers the second DVR, and store the firmware version identity provided by the second DVR in a record where the communication address of the second DVR is stored. In other examples, the first DVR may record a relation which associates the communication address and the identity of a second DVR with the firmware version identity provided by the second DVR. Contents in the response message which includes the firmware version identity may differ according to the implementation manner adopted. For example, when the communication is implemented using the IP mechanism, the response message may only include a firmware version identity, and the IP address of the DVR that sent the response message may be obtained from the IP packet header of the response message. In other examples, the response message may include a firmware version identity and an identity of the second DVR. The first DVR that received the response message may search records of communication addresses and identities of DVRs obtained in the previous search process to obtain the communication address of the second DVR. There are various other schemes which are not enumerated herein.

According to examples, a first DVR requests firmware version identities of other DVRs in the LAN where the first DVR belongs, determines the firmware version identity of the latest firmware version, request files of the latest firmware version from a third DVR that provided the firmware version identity of the latest firmware version, and performs version update using the files obtained. According to the mechanism, no management server or firmware server is needed. After one or multiple DVRs in a LAN are updated (e.g., an administrator may manually update the one or multiple DVRs), other DVRs in the LAN can perform version update automatically. As such, automatic update of DVRs is implemented. Further, since update procedures are distributed to multiple DVRs within the LAN, the efficiency of the update process is improved, especially when there are a large number of DVRs to be updated.

The method of updating DVRs is illustrated by taking the processes as shown in FIGS. 4, 5 and 6 as an example. In the following examples, the DVR that initiates an update process is referred to as the first DVR, and the other DVRs are referred to as second DVRs or a server DVR.

FIG. 4 is a flowchart illustrating a method of updating DVRs in accordance with examples of the present disclosure. The method may include the following procedures.

At block S41, a first DVR (also referred to as a client DVR) sends a connect request to a second DVR (also referred to as a server DVR), and the second DVR returns a connect complete response to the first DVR after receiving the connect request.

At block S42, the first DVR sends a first request to the second DVR. After receiving the first request, the second DVR may determine whether the request is for obtaining a firmware version identity or for obtaining files according to the request.

At block S43, the second DVR sends a firmware version identity of the second DVR to the first DVR according to the first request received at S42.

The first DVR receives and records the firmware version identity of the second DVR and the IP address of the second DVR (the IP address may be obtained from the payload of the received response message or from the IP header of the received response message), and determines a firmware version identity of the latest firmware version based on the received firmware version identity. The procedure of determining the firmware version identity of the latest firmware version may include: the first DVR compares the received firmware version identity with the firmware version identity of the first DVR, selects firmware version identities that are larger than the firmware version identity of the first DVR, and determining a firmware version identity of the latest firmware version according to the selected firmware version identities.

In an example, the first DVR may disconnect the connection with the second DVR after receiving the response message. Thus, the connection may be re-established at block S44.

At block S44, the first DVR sends a connect request to one of the second DVRs that is corresponding to the firmware version identity of the latest firmware version (which is referred to as the third DVR); after receiving the connect request, the first DVR returns a connect complete response to the first DVR.

At block S45, the first DVR sends a second request to the third DVR. After receiving the second request, the third DVR may determine whether the request is for obtaining a firmware version identity or for obtaining files according to the request.

At block S46, the third DVR sends files of the firmware version of the third DVR to the first DVR according to the second request received at block S45, and the first DVR performs version update after receiving the files.

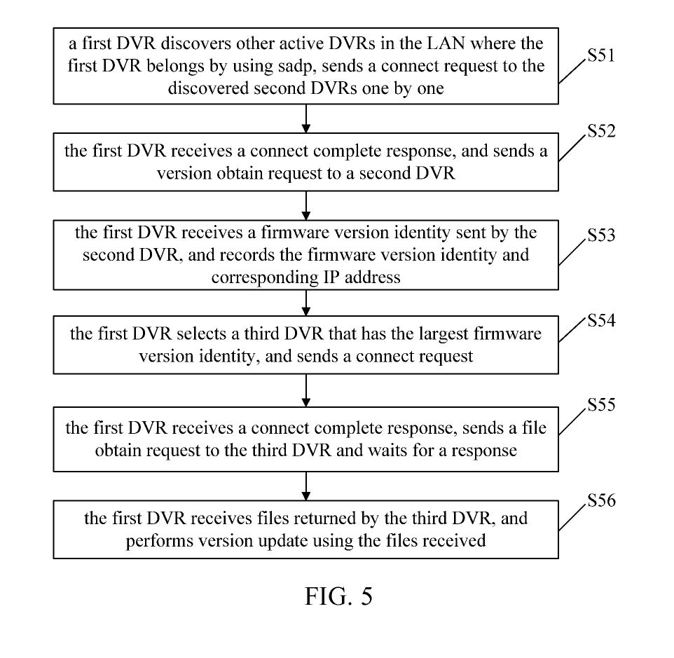

FIG. 5 is a flowchart illustrating a method of updating DVRs in accordance with examples of the present disclosure. The method may include the following procedures.

At block S51, a first DVR searches a LAN where the first DVR belongs for other active DVRs by using SADP, and sends a connect request to each of second DVRs found out.

In an example, the DVR that initiates an update process is referred to as the first DVR, and other DVRs are referred to as second DVRs.

At block S52, the first DVR receives a connect complete response, and sends a first request to a second DVR.

At block S53, the first DVR receives a firmware version identity sent by the second DVR, and records the firmware version identity with the IP address of the second DVR.

At block S54, after inquiring all of active second DVRs, the first DVR selects one of the second DVRs that has the latest firmware version (which is referred to as a third DVR), and sends a connect request to the third DVR.

The procedure of determining the version identity of the latest firmware version may include: the first DVR compares received firmware version identities with the firmware version identity of the first DVR, selects firmware version identities larger than the firmware version identity of the first DVR, and determines the firmware version identity of the latest firmware version according to the selected firmware version identities.

At block S55, the first DVR receives a connect complete response, and sends a second request to the third DVR.

At block S56, the first DVR receives files sent by the third DVR, and performs version update using the received files.

When updating the system, the first DVR may be configured to not respond to inquiry about firmware version from other clients.

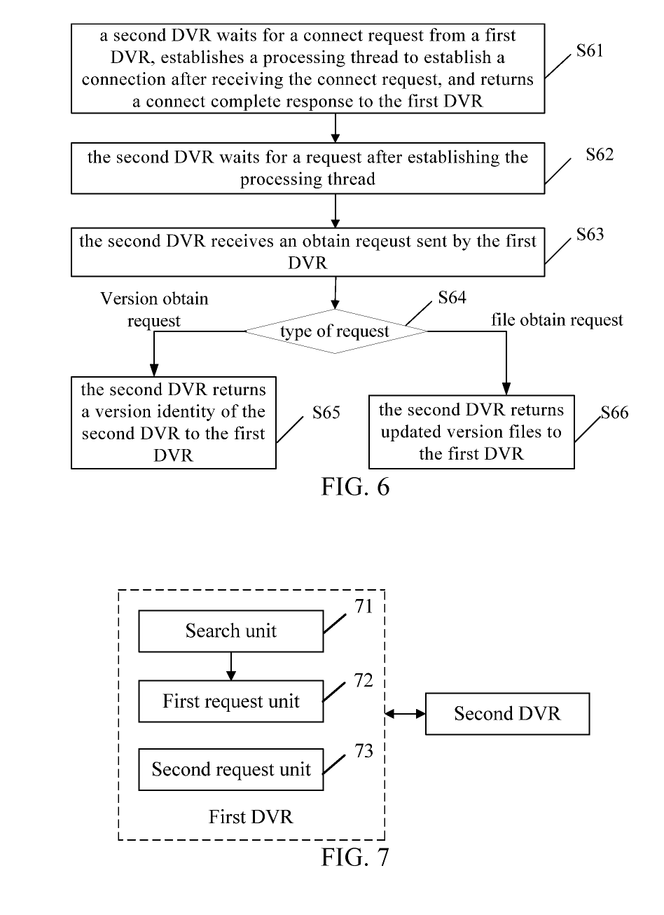

FIG. 6 is a flowchart illustrating a method of updating DVRs in accordance with examples of the present disclosure. The method may include the following procedures.

At block S61, a second DVR waits for a connect request from a first DVR, establishes a processing thread to establish a connection after receiving the connect request, and sends a connect complete response to the first DVR.

In an example, the DVR that initiates the update process is referred to as the first DVR, and other DVRs are referred to as second DVRs.

The second DVR may process multiple requests in parallel by establishing multiple processing threads.

At block S62, the second DVR waits for a request after establishing the processing thread.

At block S63, the second DVR receives an obtain request from the first DVR.

At block S64, the second DVR judges the type of the received request received at block S63, performs the procedure in block S65 if the request is for obtaining a firmware version identity, or performs the procedure in block S66 if the request is for obtaining files of the firmware version.

At block S65, the second DVR sends the firmware version identity of the second DVR to the first DVR.

At block S66, the second DVR sends files of the firmware version of the second DVR to the first DVR.

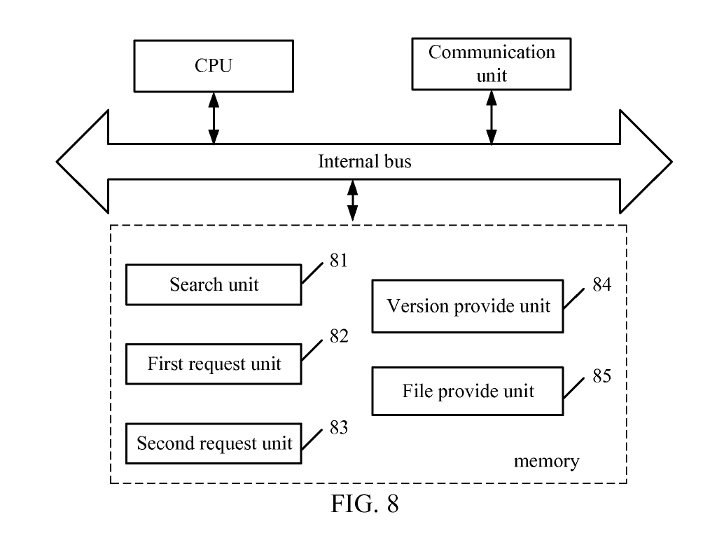

FIG. 7 is a schematic diagram illustrating a system of updating DVRs in accordance with examples of the present disclosure. The system may include plural DVRs. In this example, the DVR that initiates an update process is referred to as the first DVR, and other DVRs are referred to as second DVRs.

The first DVR is configured to obtain a firmware version identity of at least one second DVR within a LAN where the first DVR belongs, compare the obtained firmware version identity with a firmware version identity of the first DVR, determine a firmware version identity of the latest firmware version, obtain files of the latest firmware version from a third DVR that provides the firmware version identity of the latest firmware version, and perform version update using the files obtained.

In an example, the first DVR may include a first request unit 72 and a second request unit 73. The first request unit 72 is configured to obtain a firmware version identity of at least one second DVR in a LAN where the first DVR belongs, compare the firmware version identity obtained with a firmware version identity of the first DVR, and determine a version identity of the latest firmware version. The second request unit 73 is configured to obtain files of the latest firmware version from a third DVR that provides the firmware version identity of the latest firmware version, and perform version update using the files obtained.

In an example, the first request unit 72 is configured to send a first request to other DVRs in the LAN, and receive version identities and IP addresses sent by the other DVRs. The second request unit 73 is configured to compare the obtained firmware version identities with a firmware version identity of the first DVR, select firmware version identities of firmware versions newer than the firmware version of the first DVR (e.g., selecting firmware version identities larger than the firmware version identity of the first DVR), determine a firmware version identity of the latest firmware version according to selected firmware version identities, send a second request to a third DVR by using an IP address corresponding to the firmware version identity of the latest firmware version, receive files sent by the third DVR, and perform version update using the files obtained.

The third DVR is configured to send a firmware version identity of the third DVR to the first DVR in response to the first request, and send files of the firmware version of the third DVR to the first DVR in response to the second request.

In an example, the first request unit 72 is configured to send a connect request to other DVRs in the LAN where the first DVR belongs, receive connect complete responses, send the first request to the other DVRs, and receive firmware version identities and IP addresses sent by the other DVRs.

In an example, the first DVR may also include a search unit 71, configured to discover other active DVRs in the LAN by using an active device discover protocol, send a command to the first request unit 72. The first request unit 72 receives the command, and sends a connect request to the other DVRs discovered.

In an example, the second request unit 73 is configured to send a connect request to a third DVR that provides the version identity of the latest firmware version, receive a connect complete response, send a second request to the third DVR, and receive files sent by the third DVR.

The third DVR is configured to send a firmware version identity of the third DVR to the first DVR in response to the first request, and send files of the firmware version of the third DVR to the first DVR in response to the second request.

In an example, the first DVR and other DVRs are all DVRs.

FIG. 8 is a schematic diagram illustrating an example of a DVR in accordance with examples of the present disclosure. The DVR may include a CPU, a memory, a communication unit and an internal bus.

The memory stores a series of machine-readable instructions executable by the CPU to make the CPU perform actions to implement the technical mechanism of examples of the present disclosure.

The communication unit is configured to communicate with other devices in the network.

The internal bus enables communication between the units, may be a bus connected to each of the units or a collection of wires connecting the units.

In an example, the memory may store a search unit 81, a first request unit 82 and a second request unit 83. The search unit 81, the first request unit 82 and the second request unit 83 have similar functions with the above search unit 71, the first request unit 72 and the second request unit 73 respectively.

In an example, the memory may also store a version provide unit 84 and a file provide unit 85. The version provide unit 84 is configured to provide a firmware version identity of the DVR to a DVR that sent a firmware version request. The file provide unit 85 is configured to provide files of a firmware version of the DVR to a DVR that sent a file request.

According to examples, a DVR automatically detects latest firmware version in a LAN and performs system update by applying a client/server (C/S) technique and a peer-to-peer (P2P) technique to plural DVRs in the LAN, and each DVR may serve as a server DVR and a client DVR at the same time. No management server or firmware server is needed in the LAN. Server DVRs and client DVRs may establish connections and transport data using the TCP protocol.

It should be understood that in the above processes and structures, not all of the procedures and modules are necessary. Certain procedures or modules may be omitted according to the needs. The order of the procedures is not fixed, and can be adjusted according to the needs. The modules are defined based on function simply for facilitating description. In implementation, a module may be implemented by multiple modules, and functions of multiple modules may be implemented by the same module. The modules may reside in the same device or distribute in different devices. The “first”, “second” in the above descriptions are merely for distinguishing two similar objects, and have no substantial meanings.

In various embodiments, a module may be implemented by hardware and or machine-executable instructions. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

A machine-readable storage medium is also provided, which is to store instructions executable by a machine to implement the method of various examples. Specifically, a system or apparatus may have a storage medium which stores machine-readable program codes for implementing functions of any of the above examples. A computing device (or a CPU or an MPU) in the system or the apparatus may read and execute the program codes stored in the storage medium. In addition, the program codes may cause an operating system running in a computer to implement part or all of the operations. In addition, the program codes may be read out from a storage medium and be written in a storage device in an extension board inserted in the computer or in a storage device in an extension unit connected to the computer. In this example, a CPU in the extension board or the extension unit executes at least part of the operations according to the instructions of the program codes to realize the technical mechanism of any of the above examples.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. Optionally, the program code may be downloaded from a server computer via a communication network.

The scope of the claims should not be limited by the embodiments set forth in the examples, but should be given the broadest interpretation consistent with the description as a whole.

1. A method of updating digital video recorders (DVR), comprising:
obtaining, by a first DVR, a firmware version identity of at least one second DVR within a local area network (LAN) where the first DVR belongs;
comparing the obtained version identity with a firmware version identity of the first DVR, determining a firmware version identity of the latest firmware version; and
obtaining a file of the latest firmware version from a third DVR that provides the firmware version identity of the latest firmware version; and
performing version update using the file obtained.

2. The method of claim 1, wherein
the obtaining a firmware version identity of at least one second DVR in the LAN where the first DVR belongs comprises: sending, by the first DVR, a first request to the at least one DVR in the LAN, and receiving a firmware version identity and an IP address of the at least one second DVR;
the obtaining a file of the latest firmware version from the third DVR that provided the firmware version identity of the latest firmware version comprises: sending, by the first DVR, a second request to the third DVR by using an IP address corresponding to the firmware version identity of the latest firmware version, and performing version update using the file obtained.

3. The method of claim 1, wherein
the comparing the obtained firmware version identity with a firmware version identity of the first DVR and determining a firmware version identity of the latest firmware version comprises: comparing, by the first DVR, obtained firmware version identities with the firmware version identity of the first DVR, selecting firmware version identities larger than the firmware version identity of the first DVR, and determining the firmware version identity of the latest firmware version to be the largest firmware version identity in the selected firmware version identities.

4. The method of claim 1, wherein the obtaining by the first DVR a firmware version identity of the at least one second DVR in the LAN comprises:
sending, by the first DVR, a connect request to a second DVR, receiving a connect complete response, sending a first request to the second DVR, and receiving a firmware version identity of the second DVR.

5. The method of claim 1, further comprising:
discovering, by the first DVR using an active device discover protocol, at least one active DVR in the LAN as the at least one second DVR.

6. The method of claim 1, further comprising:
receiving, by the first DVR, a startup command to start an update process, and discovering other active DVRs in the LAN as the at least one second DVR by using an active device discover protocol.

7. The method of claim 1, wherein the obtaining by the first DVR a file of the latest firmware version from the third DVR that provided the firmware version identity of the latest firmware version comprises:
sending, by the first DVR, a connect request to the third DVR, receiving a connect complete response, sending a second request to the third DVR, and receiving the file sent by the third DVR.

8. A system of updating digital video recorders (DVR), comprising at least two DVRs,
a first DVR is configured to obtain a firmware version identity of at least one second DVR within a local area network (LAN) where the first DVR belongs, compare the obtained firmware version identity with a firmware version identity of the first DVR, determine a firmware version identity of the latest firmware version, obtain a file of the latest firmware version from a third DVR that provides the firmware version identity of the latest firmware version, and perform version update using the file obtained.

9. The system of claim 8, wherein the first DVR comprises a first request unit and a second request unit, wherein
the first request unit is configured to send the first request to at least one second DVR in the LAN, and receive a firmware version identity and an IP address provided by the at least one second DVR; and
the second request unit is configured to send the second request to the third DVR using an IP address corresponding to the firmware version identity of the latest firmware version, receive a file of the latest firmware version sent by the third DVR, and perform version update using the file received;
wherein the third DVR is configured to send a firmware version identity of the third DVR to the first DVR in response to the first request, and send a file of a firmware version of the third DVR to the first DVR in response to the second request.

10. The system of claim 9, wherein the second request unit is further configured to compare obtained firmware version identities with a firmware version identity of the first DVR, select firmware version identities larger than the firmware version identity of the first DVR, and determine the firmware version identity of the latest firmware version using the selected firmware version identities.

11. The system of claim 9, wherein the first request unit is configured to send a connect request to a second DVR, receive a connect complete response, send the first request to the second DVR, and receive the firmware version identity and the IP address sent by the second DVR.

12. The system of claim 9, wherein the first DVR further comprises a search unit, configured to discover other active DVRs in the LAN using an active device discover protocol, and send a command to the first request unit; the first request unit is configured to receive the command, and send the connect request to the active DVRs discovered.

13. The system of claim 9, wherein the second request unit is configured to send a connect request to the third DVR, receive a connect complete response, send the second request to the third DVR, and receive the file sent by the third DVR.

14. A digital video recorder (DVR), comprising:
a first request unit, configured to obtain a firmware version identity of at least one second DVR in a local area network (LAN) where the DVR belongs; and
a second request unit, configured to compare the obtained firmware version identity with a firmware version identity of the DVR, determine a firmware version identity of the latest firmware version, obtain a file from a third DVR that provides the firmware version identity of the latest firmware version, and perform version update using the file obtained.

15. The DVR of claim 14, wherein
the first request unit is configured to send a first request to at least one second DVR, and receive a firmware version identity and an IP address returned by the at least one second DVR; and
the second request unit is configured to send a second request to the third DVR, receive a file returned by the third DVR, and update a firmware version of the DVR using the file received.

16. The DVR of claim 14, further comprising:
a version provide unit, configured to receive a third request sent by a fourth DVR, and send a firmware version identity of the DVR to the fourth DVR; and
a file provide unit, configured to receive a fourth request sent by the fourth DVR, and send a file of the firmware version of the DVR to the fourth DVR.

17. The DVR of claim 14, further comprising:
a search unit, configured to discover at least one active DVR in the LAN using an active device discover protocol, and provide the discovered at least one DVR to the first request unit.

18. The method of claim 1, further comprising:
receiving, by the first DVR, a third request sent by a fourth DVR, and sending a firmware version identity of the first DVR to the fourth DVR; and
receiving, by the first DVR, a fourth request sent by the fourth DVR, and sending a file of a firmware version of the first DVR to the fourth DVR.

19. The system of claim 8, wherein the first DVR comprising:
a version provide unit, configured to receive a third request sent by a fourth DVR, and send a firmware version identity of the DVR to the fourth DVR; and
a file provide unit, configured to receive a fourth request sent by the fourth DVR, and send a file of the firmware version of the DVR to the fourth DVR.
